(19) United States
(12) Patent Application Publication
(10) Pub. No.: US 2013/0227430 A1
(43) Pub. Date: Aug. 29, 2013

(54) APPARATUS AND METHOD FOR DISPLAYING AN E-MAIL IN A PORTABLE TERMINAL

(71) Applicant: SAMSUNG ELECTRONICS CO., LTD., (US)

(72) Inventors: Dae-Beom KANG, Gyeonggi-do (KR); Kyung-Shin LEE, Gyeonggi-do (KR)

(73) Assignee: SAMSUNG ELECTRONICS CO., LTD., Gyeonggi-do (KR)

(21) Appl. No.: 13/774,535

(22) Filed: Feb. 22, 2013

(30) Foreign Application Priority Data
Feb. 24, 2012 (KR) 10-2012-0019364

(51) Int. Cl. H04L 12/58

(52) U.S. Cl. CPC H04L 51/00
USPC 715/752

(57) ABSTRACT

An e-mail displaying apparatus and method in a portable terminal transmits a predetermined e-mail, and outputs the transmitted predetermined e-mail in a display, then displays a reason of a transmission failure when the transmission failure occurs in a form of an icon or in a pop-up window.

### CLAIM OF PRIORITY

This application claims the priority under 35 U.S.C. §119(a) from an earlier Korean Application Serial No. 10-2012-0019364, which was filed in the Korean Intellectual Property Office on Feb. 24, 2012, the entire content of which is hereby incorporated by reference.

### BACKGROUND OF THE INVENTION

1. Field of the Invention

The present invention relates generally to a portable terminal, and more particularly, to an apparatus and method for displaying an e-mail in a portable terminal.

2. Description of the Related Art

Recently, as a function of a mobile terminal has been advanced including a camera function, a multimedia playback function, games, and the like. Various multimedia functions have been introduced gradually due to an improved display technology and availability of and high-speed communication. Accordingly, the mobile terminal has been merged as an ultimate portable entertainment system.

An e-mail function is one of the various applications. The e-mail function receives at least one mail from a mail server by synchronizing with the mail server and displays the received mail, or transmits an email to a predetermined mail address.

However, when transmission of an e-mail fails, the portable terminal displays a message indicating the transmission failure as a one-time event and thus, the portable terminal is not provided with any feedback associated with the transmission failure of an e-mail.

### SUMMARY OF THE INVENTION

Accordingly, an aspect of the present invention is to solve at least the above-described problems occurring in the prior art and provides additional advantages, by providing at least the advantages described below.

Another aspect of the present invention is to provide an e-mail displaying apparatus and method that continuously displays an e-mail and a reason of a transmission failure of the e-mail after the transmission.

In accordance with another aspect of the present invention, an apparatus for displaying an e-mail in a portable terminal includes a display unit for displaying at least one email for transmission, and a controller for storing the least one emails after the transmission in an outbox, displaying the at least one email after the transmission on the display, and indicating a reason of a transmission failure next to the displayed at least one email.

In accordance with another aspect of the present invention, a method of displaying an e-mail in a portable terminal includes transmitting at least one email, and displaying the at least one email after the transmission and indicating a reason of a transmission failure next to the displayed at least one email when the transmission failure occurs.

According to embodiments of the present invention, an e-mail transmission status and a reason behind the transmission failure of the e-mail are continuously displayed when an e-mail failure occurs and thus, the feedback associated with a transmission failure be effectively provided to a user for a subsequent retransmission.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating a portable terminal according to embodiments of the present invention;

FIG. 2 is a flowchart illustrating an e-mail process in a portable terminal according to a first embodiment of the present invention;

FIG. 3 is a flowchart illustrating an e-mail process in a portable terminal according to a second embodiment of the present invention;

FIG. 4 is a diagram illustrating a screen that displays an e-mail according to the first embodiment of the present invention;

FIG. 5 is a diagram illustrating a screen that displays an e-mail according to the first embodiment of the present invention;

FIG. 6 is a diagram illustrating a screen that displays an e-mail according to the second embodiment of the present invention; and

FIG. 7 is a flowchart illustrating a process of displaying an e-mail in a portable terminal according to a third embodiment of the present invention.

### DETAILED DESCRIPTION OF EMBODIMENTS

Hereinafter, various embodiments of the present invention will be described with reference to the accompanying drawings. Further, for the purposes of clarity and simplicity, a detailed description of well-known functions and configurations incorporated herein will be omitted as it may make the subject matter of the present invention rather unclear.

According to embodiments of the present invention, a portable terminal whereto the teachings of the present invention can be applicable to may be a portable electronic device which is mobile, including a video phone, a portable phone, a smart phone, any duplex terminal, an International Mobile Telecommunication 2000 (IMT-2000) terminal, a WCDMA terminal, a Universal Mobile Telecommunication Service (UMTS) terminal, a Personal Digital Assistant (PDA), a Portable Multimedia Player (PMP), a Digital Multimedia Broadcasting (DMB) terminal, an E-Book, a portable computer such as a Notebook, a Tablet, and the like, a digital camera.

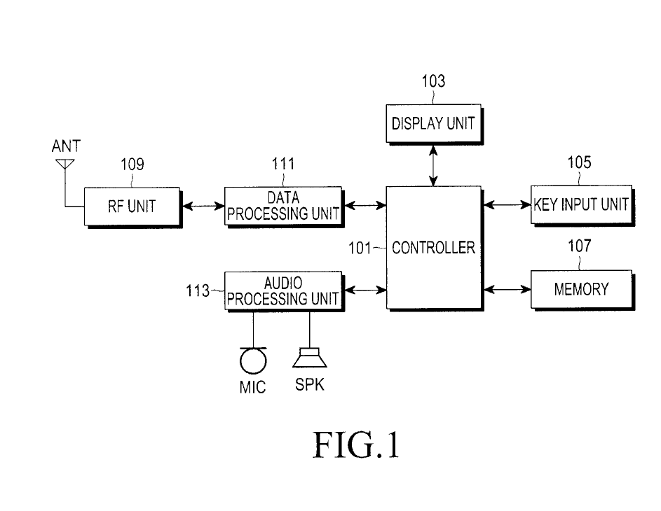

FIG. 1 is a block diagram illustrating a portable terminal according to embodiments of the present invention.

Referring to FIG. 1, the portable terminal includes a controller 101, a display unit 103, a key input unit 105, a memory 107, an RF unit 109, a data processing unit 111, and an audio processing unit 113.

In operation, the RF unit 109 performs a wireless communication function of the portable terminal. In particular, the RF unit 109 includes a wireless transmitter to up-convert and to amplify a frequency of a transmitted signal, a wireless receiver to low-noise amplify a received signal and to down-convert a frequency, and the like. The data processing unit 111 includes a transmitter to encode and modulate a transmitted signal, a receiver to demodulate and decode a received signal, and the like. Here, the data processing unit 117 may include a modem and a codec, and the codec includes a data codec to process packet data and the like and an audio codec to process an audio signal such as a voice signal and the like.

The audio processing unit 113 plays back, through a speaker, a received audio signal output from the data processing unit 111, or transmits a transmitted audio signal generated from a microphone to the data processing unit 111. The key input unit 105 includes keys required for inputting number and character information, and function keys required for setting various functions. The display unit 103 displays an image signal on a screen, and displays data of which output is requested from the controller 110.

When the display unit 103 is implemented with a touch display screen, such as a capacitive scheme or a resistive scheme, the key input unit 105 may include predetermined keys, and the display unit 103 may be substituted for a part of a key input function of the key input unit 105.

The memory 107 includes a program memory and a data memory. Here, the program memory stores a booting and Operating System (OS) for controlling general operations of the portable terminal, and the data memory stores various data generated while the portable terminal operates.

The controller 101 controls general operations of the portable terminal. In particular, when transmission of a predetermined e-mail fails, the controller 101 outputs a display indicating a reason of a transmission failure of the e-mail in form of, for example, an icon or a pop-up window.

In a first embodiment, when an e-mail application is executed by a user, the controller 101 generates an e-mail including characters, symbols and/or numbers in response to a request of writing an e-mail, and transmits the generated e-mail to a mail server. In this example, when the user requests an attachment of any types of files, the controller 101 may generate an e-mail including the data of which attachment is requested, the e-mail application corresponds to an application that performs functions of receiving, sending, and writing an e-mail. Thereafter, the mail server receives an e-mail from the portable terminal, and transmits the received e-mail to a receiver of the e-mal.

The controller 101 determines whether an e-mail transmission failure occurs, and the e-mail transmission failure may occur due to various reasons. For example, it may be a case in which a network between the portable terminal and the mail server is not connected, a case in which a word or a phrase that is banned by the portable terminal is included in an e-mail, a case in which a capacity of an e-mail exceeds a capacity supported by the mail server, a case in which a word or a phrase that is banned by the server is included in an e-mail, a case in which a receiver of an e-mail is banned by the mail server, a case in which a receiver of an e-mail does not exist in the mail server, and a case in which the mail server does not respond to transmission of an e-mail, etc.

When the transmission failure occurs, the controller 101 generates information indicating a reason of the transmission failure, and stores the e-mail transmission failure information to correspond to the e-mail of which transmission fails. In this example, the controller 101 determines the reason behind the transmission failure by the portable terminal and generates the e-mail transmission failure information indicating the determined failure reason, or receives the reason of the transmission failure from the mail server and generates the e-mail transmission failure information including the received reason of the transmission failure.

When a display of a transmission failure for a particular email is requested by the user, the controller 101 determines a reason of the transmission failure. The controller 101 outputs via display to indicate the reason behind the transmission failure pertaining to the particular e-mail.

For example, when the reason of the transmission failure associated with a predetermined e-mail corresponds to the case in which the network with the mail server is not connected, the controller 101 may display an icon indicating ‘network error’ or a pop-up window including a phrase of ‘network error’. As another example, when the reason corresponds to the case in which a capacity of the e-mail exceeds the capacity supported by the mail server, the controller 101 may display an icon indicating ‘e-mail capacity exceeded’ or a pop-up window including a phase of ‘e-mail capacity exceeded’. As another example, when the corresponds to the case in which the mail server does not respond to transmission of the e-mail, the controller 101 displays an icon indicating ‘server error’ or a pop-up window including ‘server error’.

In a second embodiment, when the e-mail application is executed by the user, the controller 101 generates an e-mail in response to an input by the user, and transmits the generated e-mail to the mail server. In this example, when the user requests attachment of predetermined data, the controller 101 may generate an e-mail including the data of which attachment is requested. When a request for transmission of the generated e-mail is executed, the controller 101 may store the generated e-mail in a mail box folder for an e-mail to be sent or a mail box folder for a sent e-mail.

The controller 101 determines whether an e-mail transmission failure occurs when an e-mail is transmitted. Again, the e-mail transmission failure may occur due to various reasons. For example, the reason of the e-mail transmission failure may include a case in which a network between the portable terminal and the mail server is not connected, a case in which a word or a phrase that is banned by the portable terminal is included in an e-mail, a case in which a capacity of an e-mail exceeds a capacity supported by the mail server, a case in which a word or a phrase that is banned by the server is included in an e-mail, a case in which a receiver of an e-mail is banned by the mail server, a case in which a receiver of an e-mail does not exist in the mail server, and a case in which the mail server does not respond to transmission of an e-mail.

When the transmission failure occurs, the controller 101 generates e-mail transmission failure information including a reason of the failure, and stores the generated e-mail transmission failure information to correspond to that particular e-mail. In this example, the controller 101 determines the reason of the failure and generates the e-mail transmission failure information including the determined reason of the transmission failure, or receives the reason of the transmission failure from the mail server and generates the e-mail transmission failure information including the received reason of the failure.

Alternatively, the controller 101 determines whether the determined reason of the transmission failure corresponds to a mail modification condition. Here, the mail modification condition is a condition in which a reason of an e-mail transmission failure is resolved by the user. For example, the mail modification condition may include the case in which a word or a phrase that is banned by the portable terminal is included in an e-mail, the case in which a capacity of an e-mail exceeds the capacity supported by the mail server, the case in which a word or a phrase that is banned by the server is included in an e-mail, and the case in which a receiver of an e-mail does not exist in the mail server.

When the determined reason of the transmission failure corresponds to the mail modification condition, the controller 101 stores the e-mail that has failed in a folder that enables the user to rewrite an e-mail. Here, the folder that enables rewriting may include a temporary storage box folder or a draft folder.

Conversely, when the determined reason of the transmission failure does not correspond to the mail modification condition, the controller 101 may store the e-mail that has failed in a folder for retransmission. Here, the folder may include a mail box folder for an e-mail to be sent or a mail box folder for a sent e-mail. In this example, when the e-mail that has failed is already stored in the mail box folder for an e-mail to be sent or the mail box folder for a sent e-mail, the controller 101 may maintain the e-mail that has failed is stored in the mail box folder for an e-mail to be sent or the mail box folder for a sent e-mail, as it is.

When a display of the e-mail that has failed is requested by the user, the controller 101 determines the reason of the transmission failure associated with the failed e-mail. The controller 101 displays the reason of the transmission failure of the e-mail via display unit.

For example, when the reason of the failure corresponds to the case in which the network with the mail server is not connected, the controller 101 may display an icon indicating ‘network error’ or a pop-up window including a phrase of ‘network error’. As another example, when the reason corresponds to the case in which a capacity of the e-mail exceeds the capacity supported by the mail server, the controller 101 may display an icon indicating ‘e-mail capacity exceeded’ or a pop-up window including a phase of ‘e-mail capacity exceeded’. As another example, when the reason corresponds to the case in which the mail server does not respond to transmission of the e-mail, the controller 101 displays an icon indicating ‘server error’ or a pop-up window including ‘server error’.

In a third embodiment, the controller 101 determines whether the e-mail application is executed by the user, and if so, the controller 101 determines whether a mail box for an e-mail to be sent is selected by the user. Here the mail box for an e-mail to be sent may include an e-mail to be sent, and particularly, may include an e-mail of which transmission fails.

When the mail box for an e-mail to be sent is selected, the controller 101 displays an e-mail that has failed in the mail box for retransmission. The controller 101 detects e-mail transmission failure information corresponding to the displayed e-mail and determines a reason of a transmission failure using the detected e-mail transmission failure information.

The controller 101 outputs a display indicating the reason of the transmission failure to correspond to the displayed e-mail in form of an icon or a pop-up window. For example, when a reason of a transmission failure corresponds to a case in which a network with the mail server is not connected, the controller 101 may display an icon indicating ‘network error’ or a pop-up window including a phrase of ‘network error’. As another example, when the reason of the transmission failure corresponds to a case in which a capacity of the e-mail exceeds the capacity supported by the mail server, the controller 101 may display an icon indicating ‘e-mail capacity exceeded’ or a pop-up window including a phase of ‘e-mail capacity exceeded’. As another example, when the reason of the transmission failure corresponds to a case in which the mail server does not respond to transmission of the e-mail, the controller 101 displays an icon indicating ‘server error’ or a pop-up window including ‘server error’.

The controller 101 determines whether retransmission of the displayed e-mail that has failed is requested by the user. In this example, the user modifies the e-mail to remedy the transmission failure, and requests, from the controller 101, the retransmission of the modified e-mail.

When the retransmission is requested, the controller 101 determines whether an e-mail transmission failure occurs during the retransmission. Here, the e-mail transmission failure may occur due to various reasons. For example, the reason of the e-mail transmission failure may include a case in which a network between the portable terminal and the mail server is not connected, a case in which a word or a phrase that is banned by the portable terminal is included in an e-mail, a case in which a capacity of an e-mail exceeds a capacity supported by the mail server, a case in which a word or a phrase that is banned by the server is included in an e-mail, a case in which a receiver of an e-mail is banned by the mail server, a case in which a receiver of an e-mail does not exist in the mail server, and a case in which the mail server does not respond to transmission of an e-mail.

When the retransmission failure occurs, the controller 101 generates e-mail transmission failure information including a reason of the retransmission failure, and stores the generated e-mail transmission failure information to correspond to the e-mail of which retransmission fails. In this example, the controller 101 determines the reason of the retransmission failure by the portable terminal and generates the e-mail transmission failure information including the determined reason of the retransmission failure, or receives the reason of the retransmission failure from the mail server and generates the e-mail transmission failure information including the received reason of the retransmission failure.

Subsequently, when the mail box for an e-mail to be sent is selected by the user and an e-mail of which transmission that has failed is displayed, the controller 101 displays a reason of a transmission failure associated with the displayed e-mail using stored e-mail transmission failure information.

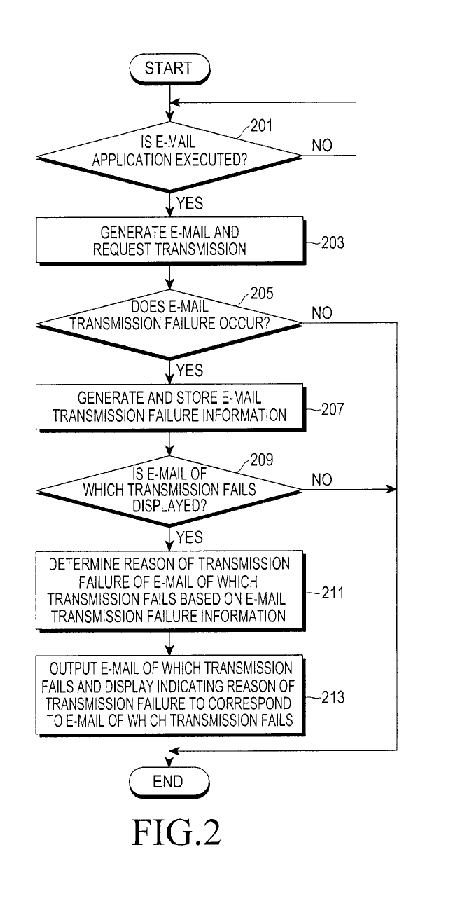

FIG. 2 is a flowchart illustrating an e-mail process in a portable terminal according to the first embodiment of the present invention.

Referring to FIG. 2, the portable terminal determines whether an e-mail application is executed by a user in step S201. Then the e-mail application is executed, the portable terminal proceeds with step S203, and when the e-mail application is not executed, the portable terminal repeatedly performs step S201. Here, the e-mail application corresponds to an application that performs functions of receiving, sending, and writing an e-mail.

When an operation proceeds with step S203, the portable terminal may generate an e-mail including characters, numbers, and symbols, etc., entered by the user, requests transmission of the generated e-mail from a mail server, and the proceed to step S205. In this example, when the user requests an attachment of any type of files the portable terminal generates an e-mail including the file containing data of which attachment is requested. Here, a mail server corresponds to a server that receives an e-mail from the portable terminal, and transmits the received e-mail to a receiver of the e-mail.

In step S205, the portable terminal determines whether an e-mail transmission failure occurs when the e-mail is transmitted. Here, the e-mail transmission failure may occur due to various reasons. For example, the reason of the e-mail transmission failure may include a case in which a network between the portable terminal and the mail server is not connected, a case in which a word or a phrase that is banned by the portable terminal is included in an e-mail, a case in which a capacity of an e-mail exceeds a capacity supported by the mail server, a case in which a word or a phrase that is banned by the server is included in an e-mail, a case in which a receiver of an e-mail is banned by the mail server, a case in which a receiver of an e-mail does not exist in the mail server, and a case in which the mail server does not respond to transmission of an e-mail.

When the transmission failure occurs, the portable terminal may proceed with step S207.

When the operation proceeds with step S207, the portable terminal generates e-mail transmission failure information including a reason of a transmission failure, and stores the generated transmission failure information to correspond to the failed e-mail, and proceeds with step S209. In this example, the portable terminal determines the failure reason and generates the e-mail transmission failure information that includes the determined failure reason, or receives the failure reason from the mail server and generates the e-mail transmission failure information that includes the received failure reason. Alternatively, the portable terminal may not generate the transmission failure information, and may directly receive transmission failure reason information from the mail server for storage.

In step S209, the portable terminal determines whether a display of a predetermined e-mail that has failed is requested by the user. When the display of the e-mail that has failed is requested, the portable terminal proceeds with step S211, and when the display is not requested, the portable terminal terminates the operation.

In step S211, the portable terminal determines the reason of the transmission failure associated a predetermined e-mail using the e-mail transmission failure information, which is determined by the terminal or a server, and proceeds with step S213. In step S213, the portable terminal displays the reason of the transmission failure of the predetermined e-mail.

For example, when the reason of the transmission failure associated with the predetermined e-mail corresponds to the case in which the network with the mail server is not connected, the portable terminal may display an icon indicating ‘network error’ or a pop-up window including a phrase of ‘network error’. As another example, when the reason of the transmission failure associated with the predetermined e-mail corresponds to the case in which a capacity of the e-mail exceeds the capacity supported by the mail server, the portable terminal may display an icon indicating ‘e-mail capacity exceeded’ or a pop-up window including a phase of ‘e-mail capacity exceeded’. As another example, when the reason of the transmission failure associated with the predetermined e-mail corresponds to the case in which the mail server does not respond to transmission of the e-mail, the portable terminal displays an icon indicating ‘server error’ or a pop-up window including ‘server error’.

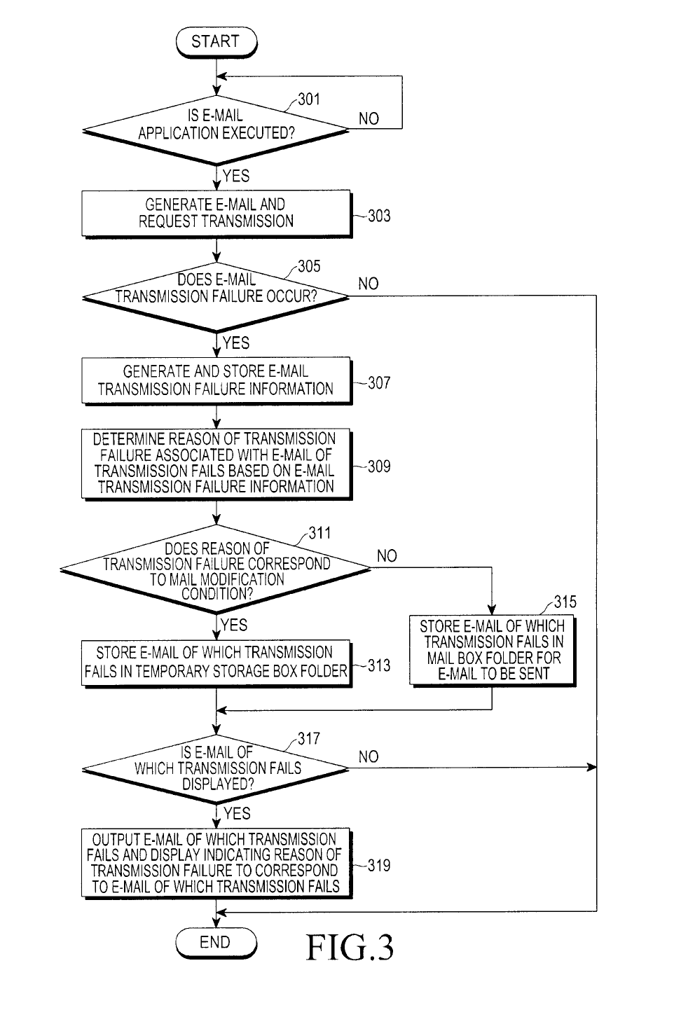

FIG. 3 is a flowchart illustrating an e-mail in a portable terminal according to the second embodiment of the present invention.

Referring to FIG. 3, in step S301, the portable terminal determines whether an e-mail application is executed by a user. When the e-mail application is executed, the portable terminal proceeds with step S303, and when the e-mail application is not executed, the portable terminal repeatedly performs step S301.

When an operation proceeds with step S303, the portable terminal generates an e-mail including characters input, requests transmission of the generated e-mail to a mail server, and proceeds with step S305. In this example, when the user requests attachment of any type of files, the portable terminal may generate an e-mail including the data of which attachment is requested. When a request for transmission of the generated e-mail is executed, the portable terminal may store the generated e-mail in a mail box folder for an e-mail to be sent or a mail box folder for a sent email.

When the operation proceeds with step S305, the portable terminal determines whether an e-mail transmission failure occurs. Here, the e-mail transmission failure may occur due to various reasons. For example, the reason of the e-mail transmission failure may include a case in which a network between the portable terminal and the mail server is not connected, a case in which a word or a phrase that is banned by the portable terminal is included in an e-mail, a case in which a capacity of an e-mail exceeds a capacity supported by the mail server, a case in which a word or a phrase that is banned by the server is included in an e-mail, a case in which a receiver of an e-mail is banned by the mail server, a case in which a receiver of an e-mail does not exist in the mail server, and a case in which the mail server does not respond to transmission of an e-mail.

When the transmission failure occurs, the portable terminal proceeds with step S307, and if not, the portable terminal terminates the operation.

When the operation proceeds with step S307, the portable terminal generates e-mail transmission failure information including the reason of the transmission failure, stores the generated e-mail transmission failure information to correspond to the failed e-mail, and proceeds with step S309. In this example, the portable terminal determines the reason of the transmission failure and generates the e-mail transmission failure information including the determined reason of the transmission failure, or receives the reason of the transmission failure from the mail server and generates the e-mail transmission failure information including the received reason of the transmission failure. The portable terminal may not generate the transmission failure information, and may directly receive transmission failure reason information from the mail server and store the transmission failure reason information.

In step S309, the portable terminal determines a reason of a transmission failure associated with a predetermined e-mail using e-mail transmission failure information, and proceeds with step S311. In step S311, the portable terminal determines whether the determined reason of the transmission failure corresponds to a mail modification condition. Here, the mail modification condition corresponds to a condition in which a reason of an e-mail transmission failure can be resolved by the user. For example, the mail modification condition may include the case in which a word or a phrase that is banned by the portable terminal is included in an e-mail, the case in which a capacity of an e-mail exceeds the capacity supported by the mail server, the case in which a word or a phrase that is banned by the server is included in the e-mail, and the case in which a receiver of an e-mail does not exist in the mail server.

When the determined reason of the transmission failure corresponds to the mail modification condition, the portable terminal proceeds with step S313 and when the determined reason does not correspond to the mail modification condition, the portable terminal proceeds with step S315.

When the operation proceeds with step S313, the portable terminal stores the e-mail of which transmission fails in a temporary storage box folder or a draft folder, and proceeds with step S317. Conversely, when the operation proceeds with step S315, the portable terminal stores the e-mail of which transmission fails in a mail box folder for an e-mail to be sent or a mail box folder for a sent e-mail, and proceeds with step S317. In this example, when the e-mail of which transmission fails is already stored in the mail box for an e-mail to be sent or the mail box folder for a sent e-mail, the portable terminal may maintain the e-mail of which transmission fails that is stored in the mail box for an e-mail to be sent or the mail box folder for a sent e-mail, as it is.

In step S317, when a display of the predetermined e-mail that has filed is requested, the portable terminal determines the reason of the transmission failure associated with the predetermined e-mail of which transmission fails using the e-mail transmission failure information. The portable terminal outputs the predetermined e-mail that failed fails and displays the reason of the transmission failures. For example, when the reason of the transmission failure associated with the predetermined e-mail corresponds to the case in which the network with the mail server is not connected, the portable terminal may display an icon indicating ‘network error’ or a pop-up window including a phrase of ‘network error’. As another example, when the reason of the transmission failure associated with the predetermined e-mail corresponds to the case in which a capacity of the e-mail exceeds the capacity supported by the mail server, the portable terminal may display an icon indicating ‘e-mail capacity exceeded’ or a pop-up window including a phase of ‘e-mail capacity exceeded’. As another example, when the reason of the transmission failure associated with the predetermined e-mail corresponds to the case in which the mail server does not respond to transmission of the e-mail, the portable terminal displays an icon indicating ‘server error’ or a pop-up window including ‘server error’.

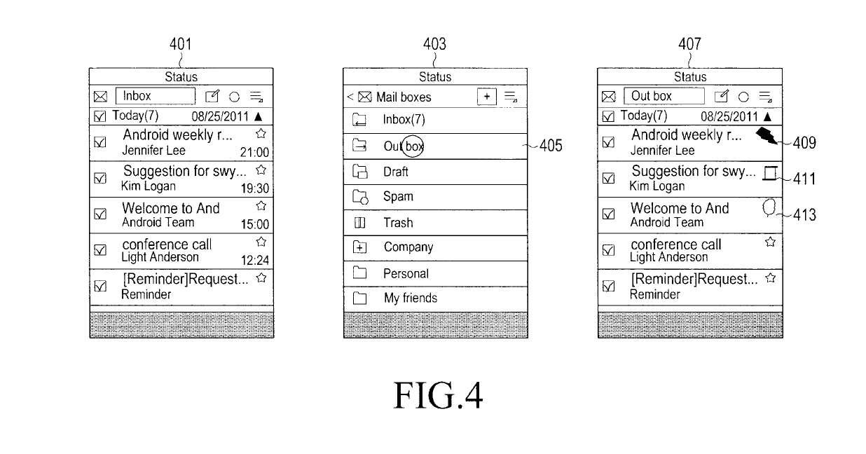

FIG. 4 illustrates a screen that displays an e-mail according to the first embodiment of the present invention

Referring to FIG. 4, a screen 401 corresponds to a screen that displays a plurality of e-mails included in an inbox after an e-mail application is executed.

In the screen 401, when transmission of the plurality of e-mails included in the inbox is requested by a user, the e-mails may be transmitted to receivers and stored in an outbox.

A screen 403 corresponds to a screen showing a mail box list. Here, the mail box list includes an inbox, an out box 405, and a draft. In the screen 403, when the outbox 405 is selected by the user, the portable terminal may output a screen 407.

Here, the screen 407 corresponds to a screen that displays e-mails of which transmission fails and an icon indicating a reason of a failure corresponding to each e-mail of which transmission fails. For example, when a reason of a transmission failure of a first e-mail (Android weekly) from among the plurality of e-mails included in the outbox corresponds to a case in which a network with a mail server is not connected, the portable terminal may display an icon 409 indicating ‘network error’ together with the first e-mail. As another example, when a reason of a transmission failure of a second mail (Suggestion for) corresponds to a case in which a capacity of an e-mail exceeds a capacity supported by the mail server, the portable terminal may display an icon 411 indicating ‘e-mail capacity exceeded’. As another example, when a reason of a transmission failure of a third mail (Welcome to) corresponds to a case in which the mail server does not respond to transmission of an e-mail, the portable terminal may display an icon 413 indicating ‘server error’.

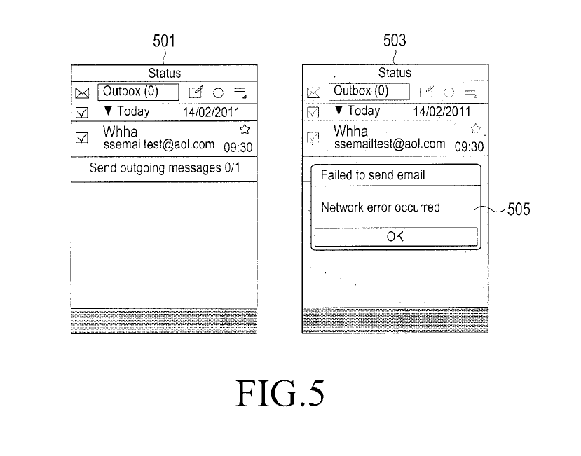

FIG. 5 illustrates a screen that displays an e-mail according to the first embodiment of the present invention.

Referring to FIG. 5, a screen 501 corresponds to a screen displaying at least one e-mail included in an outbox. In the screen 501, when an e-mail is selected by a user, the portable terminal determines whether transmission of the selected e-mail succeeds or fails based on a predefined signal protocol. When the transmission of the selected e-mail fails, the portable terminal may display a pop-up window 505 including a reason of a transmission failure of the selected e-mail as shown in the screen 503.

For example, when the reason of the transmission failure of the selected e-mail corresponds to a case in which a network with a mail server is not connected, the portable terminal may output a pop-up window including a phrase of ‘network error’.

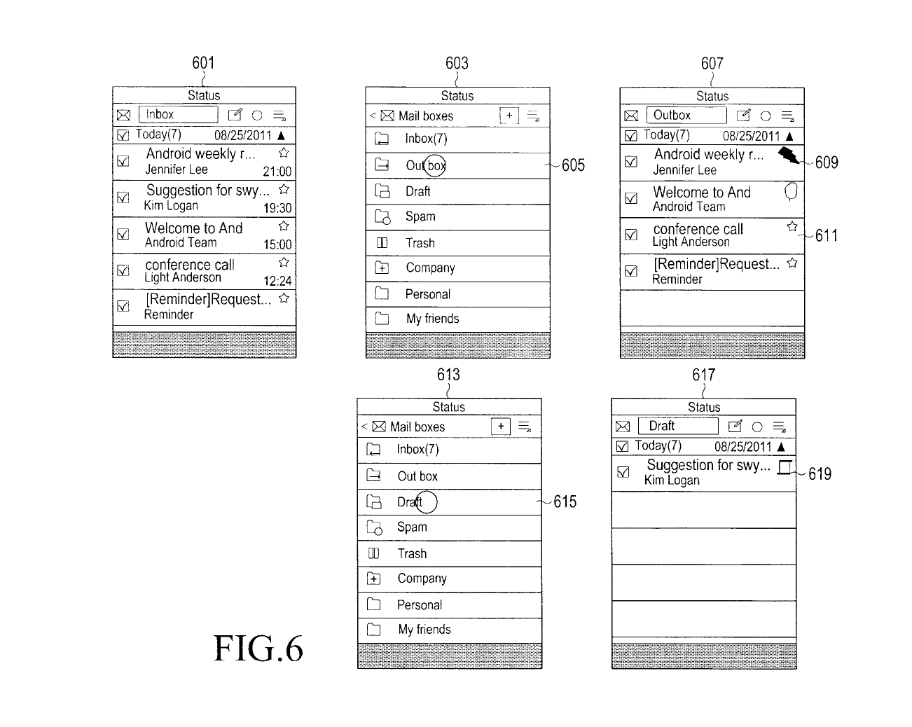

FIG. 6 illustrates a screen that displays an e-mail according to the second embodiment of the present invention.

Referring to FIG. 6, a screen 601 corresponds to a screen displaying a plurality of e-mails included in an inbox after an e-mail application is executed.

In the screen 601, when transmission of the plurality of e-mails included in the inbox is requested by a user, the plurality of e-mails may be transmitted to respective receivers and each e-mail of which transmission has failed may be stored in one of an outbox folder and a draft folder based on a corresponding reason of a transmission failure.

A screen 603 and a screen 613 correspond to screens showing a mail box list. Here, the mail box list includes an inbox, an outbox 605, and a draft 615.

When the outbox 605 is selected by the user in the screen 603, the portable terminal outputs a screen 607. Here, the screen 607 corresponds to a screen displaying e-mails that have failed and an icon indicating a reason of a transmission failure to correspond to each e-mail. For example, when a reason of a transmission failure of a first e-mail (Android weekly) from among the plurality of mails included in the outbox corresponds to a case in which a network with a mail server is not connected, the portable terminal may display an icon 609 indicating ‘network error’ together with the first e-mail. As another example, when a reason of a transmission failure of a second mail (Welcome to) corresponds to a case in which the mail server does not respond to transmission of an e-mail, the portable terminal may display an icon 611 indicating ‘server error’.

When the draft 615 is selected by the user in the screen 613, the portable terminal outputs a screen 617. Here, the screen 617 corresponds to a screen that displays at least one e-mail where transmission has failed and an icon indicating a reason of a transmission failure next to the corresponding at least one e-mail.

For example, when a reason of a transmission failure of a first mail (Suggestion for) included in the draft 615 corresponds to a case in which a capacity of an e-mail exceeds a capacity supported by the mail server, the portable terminal may display an icon 619 indicating ‘e-mail capacity exceeded’.

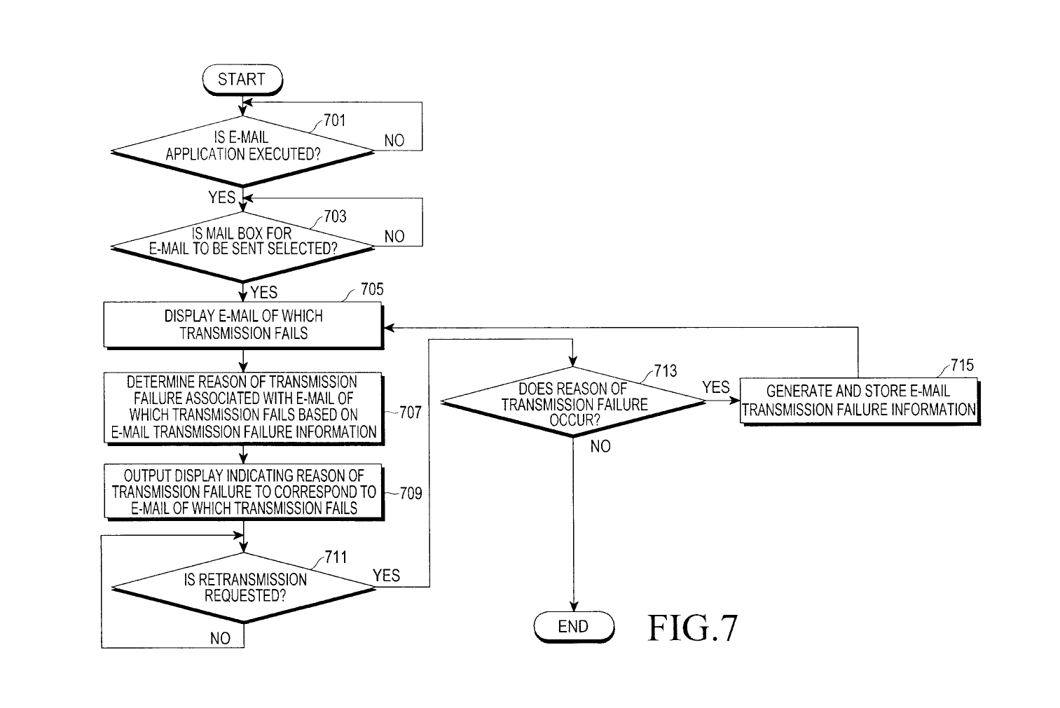

FIG. 7 is a flowchart illustrating a process of displaying an e-mail in a portable terminal according to the third embodiment of the present invention.

Referring to FIG. 7, the portable terminal determines whether an e-mail application is executed by a user in step S701. When the e-mail application is executed, the portable terminal proceeds with step S703, and when the e-mail application is not executed, the portable terminal repeatedly performs step S701. Here, the e-mail application corresponds to an application that performs functions of receiving, sending, and writing an e-mail.

When an operation proceeds with step S703, the portable terminal determines whether a mail box for an e-mail to be sent is selected by the user. Here, the mail box for an e-mail to be sent includes an e-mail to be sent, and particularly, may include an e-mail whose transmission has failed. When the mail box for an e-mail to be sent is selected, the portable terminal proceeds with step S705, and when the mail box for an e-mail to be sent is not selected, the portable terminal proceeds with step S703. When the operation proceeds with step S705, the portable terminal displays at least one e-mail that has failed from among a plurality of e-mails included in the mail box for an e-mail to be sent, and proceeds with step S707.

In step S707, the portable terminal detects e-mail transmission failure information corresponding to the displayed e-mail whose transmission has failed, determines a reason of a transmission failure associated with the failed e-mail using the detected e-mail transmission failure information, which is based on a predefined exchange protocol to determine the completion of signal transmission between entities, and proceeds with step S709.

In step S709, the portable terminal outputs a display indicating the reason of the transmission failure to correspond to the displayed e-mail whose transmission has failed, and proceeds with step S711. Here, the display may correspond to one of an icon and a pop-up window. For example, when a reason of a transmission failure associated with a predetermined e-mail corresponds to a case in which a network with a mail server is not connected, the portable terminal may display an icon indicating ‘network error’ or a pop-up window including a phrase of ‘network error’. As another example, when the reason of the transmission failure associated with the predetermined e-mail corresponds to a case in which a capacity of the e-mail exceeds a capacity supported by the mail server, the portable terminal may display an icon indicating ‘e-mail capacity exceeded’ or a pop-up window including a phase of ‘e-mail capacity exceeded’. As another example, when the reason of the transmission failure associated with the predetermined e-mail corresponds to a case in which the mail server does not respond to transmission of the e-mail, the portable terminal displays an icon indicating ‘server error’ or a pop-up window including ‘server error’.

In step S711, the portable terminal determines whether retransmission of the displayed e-mail whose transmission has failed is requested by the user. When the retransmission is requested, the portable terminal proceeds with step S713, and when the retransmission is not requested, the portable terminal repeatedly performs step S711. In this example, the user modifies the e-mail of which transmission fails to resolve the reason of the transmission failure, and requests the retransmission of the modified e-mail from the portable terminal.

When the operation proceeds with step S713, the portable terminal determines whether an e-mail transmission failure occurs during the retransmission of the e-mail. Again, the e-mail transmission failure may occur due to various reasons. For example, the reason of the e-mail transmission failure may include a case in which a network between the portable terminal and the mail server is not connected, a case in which a word or a phrase that is banned by the portable terminal is included in an e-mail, a case in which a capacity of an e-mail exceeds a capacity supported by the mail server, a case in which a word or a phrase that is banned by the server is included in an e-mail, a case in which a receiver of an e-mail is banned by the mail server, a case in which a receiver of an e-mail does not exist in the mail server, and a case in which the mail server does not respond to transmission of an e-mail.

When the retransmission failure occurs, the portable terminal proceeds with step S715, and when the retransmission failure does not occur, the portable terminal terminates an operation of displaying a reason of a transmission failure associated with a mail of which retransmission fails.

When the operation proceeds with step S715, the portable terminal generates e-mail transmission failure information including a reason of the retransmission failure, stores the generated e-mail transmission failure information to correspond to the e-mail of which retransmission fails, and proceeds with step S705. In this example, the portable terminal determines the reason of the retransmission from the portable terminal and generates the e-mail transmission failure information including the determined reason of the transmission failure, or receives the reason of the retransmission failure from the mail server and generates the e-mail transmission failure information including the received reason of the transmission failure.

Through the operations, the portable terminal continuously displays an e-mail of which transmission fails and a reason of an e-mail transmission failure and thus, feedback associated with the e-mail transmission failure may be effectively input by the user.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. An apparatus for displaying an e-mail in a portable terminal, comprising:
a display for displaying at least one email for transmission; and
a controller for storing the least one emails after the transmission in an outbox, displaying the at least one email after the transmission on the display, and indicating a reason of a transmission failure next to the displayed at least one email.

2. The apparatus of claim 1, wherein the reason of the transmission failure is displayed in a form of an icon or a pop-up window.

3. The apparatus of claim 1, wherein the controller causes to store the reason of the transmission failure for a particular email and displays the reason in response to receiving a request.

4. The apparatus of claim 3, wherein the controller causes to store, based on the reason of the transmission failure, a failed e-mail in a first folder for rewriting the failed e-mail and a second folder for retransmitting the failed e-mail.

5. The apparatus of claim 4, wherein the controller causes to store the failed e-mail in the first folder for rewriting when the reason of the transmission failure is fixable by a user.

6. The apparatus of claim 5, wherein the controller stores the failed e-mail in the second folder for retransmitting when the reason of the transmission failure is not fixable by the user.

7. The apparatus of claim 1, wherein, when a display of at least one failed e-mail is received, the controller determines a reason of a transmission failure associated a particular e-mail and causes to display the determined reason of the transmission failure in a form of an icon or a pop-up window.

8. The apparatus of claim 7, wherein, when retransmission of the failed e-mail is received, the controller determines whether retransmission of the failed e-mail is successful, and stores a reason of a retransmission failure when the retransmission fails.

9. A method of displaying an e-mail in a portable terminal, the method comprising:
Transmitting at least one email; and
displaying the at least one email after the transmission and indicating a reason of a transmission failure next to the displayed at least one email when the transmission failure occurs.

10. The method of claim 9, wherein the reason of the transmission failure is displayed in form of an icon or a pop-up window.

11. The method of claim 9, further comprising storing the reason of the transmission failure for a particular email and displaying the reason of the transmission failure in response to receiving a request.

12. The method of claim 11, wherein storing comprises:
based on the reason of the transmission failure, storing a failed e-mail in a first folder for rewriting the failed e-mail and a second folder for retransmitting the failed e-mail.

13. The method of claim 12, wherein the storing the first and the second folders comprises:
storing the failed e-mail in the first folder for rewriting when the reason of the transmission failure is fixable by a user.

14. The method of claim 13, wherein the storing the first and the second folders comprises:
storing the failed e-mail in the second folder for retransmitting when the reason of the transmission failure is not fixable by the user.

15. The method of claim 9, further comprising:
receiving a quest for a display of at least one failed e-mail is received;
determining a reason of a transmission failure associated a particular e-mail; and
displaying the determined reason of the transmission failure in a form of an icon or a pop-up window.

16. The method of claim 15, further comprising:
receiving a request for retransmission of the failed e-mail;
determining whether the retransmission of the failed e-mail is successful; and
storing a reason of a retransmission failure when the retransmission fails.
